(19) United States
(12) Patent Application Publication
(10) Pub. No.: US 2022/0383765 A1
(43) Pub. Date: Dec. 1, 2022

(54) A METHOD OF SYNCHRONIZING A SUBJECT IN A CLASS TIMETABLE TO THE PARTICULAR SESSION IN THE ADVANCED DIGITAL TEXT BOOK

(71) Applicant: Sarath KAKUMANU, Chennai (IN)

(72) Inventor: Sarath KAKUMANU, Chennai (IN)

(21) Appl. No.: 17/775,904

(22) PCT Filed: Nov. 12, 2020
(86) PCT No.: PCT/IN2020/050954

§ 371 Date: May 11, 2022

(30) Foreign Application Priority Data
Nov. 13, 2019 (IN) 201941046192

(51) Int. Cl. G09B 5/02

(52) U.S. Cl. CPC G09B 5/02

(57) ABSTRACT

A system, method and a computer program product thereof for displaying a virtually collaborated, multi-layered advanced digital text book/digital document synchronized with a corresponding timetable/schedule of classes for an educational institution having a curriculum, a plurality of faculty, and a plurality of students have been disclosed. The method facilitates synchronizing the subject in a class timetable to the session of each subject of the advanced digital text book, enabling a user to view the details of the particular session of each subject directly from the timetable. The timetable has faculty name, session number, class location details and status of the session for that particular period. The method comprises the steps of receiving a user input for displaying a schedule of classes for a specified time period; displaying the timetable for the specified time period, on a display of a user device; receiving a user input for displaying a specified content of a specific subject of the curriculum which is displayed within the timetable for the specified time period; and displaying the specified content of the specific subject of the curriculum synchronized with the timetable for the specified time period received as user input on the user device. A method of synchronizing a subject in a class timetable to the particular session in the Advanced Digital Text Book gives utmost convenient to the students and faculties and enhances their productivity.

### TECHNICAL FIELD

The present invention relates to the synchronization of timetable with an advanced digital text book/digital document. It specifically relates to the synchronizing of class timetable with session of each subject in the advanced digital text book.

### BACKGROUND OF THE INVENTION

Modem Information Technology has dramatically improved the way of education in the last decade. Recent developments in the education system through internet is advancing the digital revolution by making it possible to store and view the printed text book in a digital format on a personal computer or any other communication devices. It made irreversible changes in the education system. As a result, the digitized educational books are developed with multiple advantages for the readers.

At present, several companies are developing ‘Interactive E-Books with limited additional features. Some of them achieve various educational needs through their Learning Management Systems, LMS. Most of these LMS tools are providing the timetable in usual way only with the subject name for each period.

So far, no one has developed the link-enabled timetable that connects the relevant part of the textbook. There is no such option to move on to the particular session of the subject for that particular period which is going to be taught. So, the students have no other option except to open each subject separately and go to the relevant session in a manual way. That is time consuming process. To avoid this nagging issue, a better system is required.

The timetable/schedule of classes is the channel which supports the delivery of an effective curriculum. Whether planning a subject for the first time, or reviewing an existing subject, timetable plays a prime place for the Faculty/Student to organize their schedule and take informed decision based on their timetable schedule. It is important to consider the effects of teaching and learning. Both will not be easy without knowing the session handled for the next day. And by knowing the faculty detail and subject content earlier it is much easier for the students to learn. The present invention proposes a novel and user-friendly solution to connect the time-table (schedule of classes) to the particular session of the text book. The main objective is to have a link-enabled timetable which is to improve the current educational system.

### SUMMARY OF THE INVENTION

The following summary is provided to facilitate an understanding of some of the innovative features unique to the disclosed embodiment and is not intended to be a full description.

According to a first aspect of the present invention, a method for displaying a virtually collaborated, multi-layered advanced digital text book/digital document synchronized with a corresponding timetable/schedule of classes for an educational institution having a curriculum, a plurality of faculties (teachers, lecturers, professors) and a plurality of students has been disclosed. On receiving a user input for displaying a timetable for a specified time period, the corresponding timetable for the specified time period is displayed on a display of a user device. Further on receiving a user input for displaying a specified content of a specific subject of the curriculum which is displayed within timetable for the specified time period, the corresponding synchronized content is displayed on the display of the user device.

According to a second aspect, a virtually collaborated, multi-layered advanced digital text book/digital document display system has been disclosed. It comprises at least one user device communicably coupled to a first application server and a second application server, said advanced digital text book/digital document synchronized with a corresponding timetable/schedule of classes for an educational institution having a curriculum, a plurality of faculties and a plurality of students. The system is configured to receive a user input for displaying a timetable for a specified time period, display the timetable for the specified time period, on a display of a user device, receive a user input for displaying a specified content of a specific subject of the curriculum which is displayed within the timetable for the specified time period and display on the display of a user device, the specified content of the specific subject of the curriculum synchronized with the specific schedule of classes for the specified. time period received as user input.

Yet another aspect of the present invention is a computer program product comprising instructions, to perform a method for displaying a virtually collaborated, multi-layered advanced digital text book/digital document synchronized with a corresponding schedule of classes for an educational institution having a curriculum, a plurality of faculties and a plurality of students, the method comprising the steps of: receiving a user input for displaying a schedule of classes for a specified time period; displaying the timetable for the specified time period, on a display of a user device; receiving a user input for displaying a specified content of a specific subject of the curriculum which is displayed within the timetable for the specified time period; and displaying, on the display of a user device, the specified content of the specific subject of the curriculum synchronized with the timetable for the specified time period received as user input.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 illustrates a graphical representation of the timetable in the education management software synchronised with the session of each subject in the advanced digital textbook/digital document.

FIG. 2 illustrate a graphical representation of the student view of the advanced digital textbook/digital document after clicking the session in the timetable.

FIG. 3 illustrate a graphical representation of the student view of the timetable in advanced digital textbook/digital document after clicking the particular date in the calendar.

FIG. 4 illustrate a graphical representation of the flow diagram of synchronizing a subject in a class timetable to the particular session in the advanced digital text book.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure. Throughout the drawings, it should be noted that like reference numbers are used to depict the same or similar elements, features, and structures.

### DETAILED DESCRIPTION

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of different features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

According to an embodiment of the present invention, a synchronized digital timetable linked to the session of each subject in the advanced digital text book is disclosed. The idea is to create the most advanced form of a dynamic timetable that contains a visible link to the session of each subject for that particular period in the advanced digital textbook. It can be viewed by the Students/Faculty through their mobile as well as other communication devices like Desktop/Laptop Computer, Digital Tablets etc.

In an implementation of a disclosed embodiment is to view the specific timetable set as per the Students/Faculty login. The faculty can view the period with the link to the session of the subjects handled for each class. The students can view the subjects for each period with the faculty name handling the subject. The student can view the period with the link to the session of the different subjects for each period. It is a new and user-friendly way of synchronizing the timetable with the session in the advanced digital book in their communication devices, including but not limited to Desktop Computers/Laptop Computers, Digital Tablets and Mobile Smart Phones.

The timetable has the session number for each subject for each day. It helps the students to learn or go through the lesson which are going to be taught on the next day. Additionally, it also indicates the precise location where that particular session going to happen (including block number, floor number, room number etc.). In this way, the digital timetable enables the students to take informed decisions and be prepared for the forthcoming classroom session well in advance. The students and teachers can use this timetable as a perfect reference for the session handled every day of the week, location of the class held and completion of the session day by day.

The application permits the faculty/students to view the session of the subject for that particular period directly by clicking the link in the Timetable. This way, seamless connectivity between timetable and digital book is assured in the timetable itself, instead of clicking and viewing the session of the subject separately.

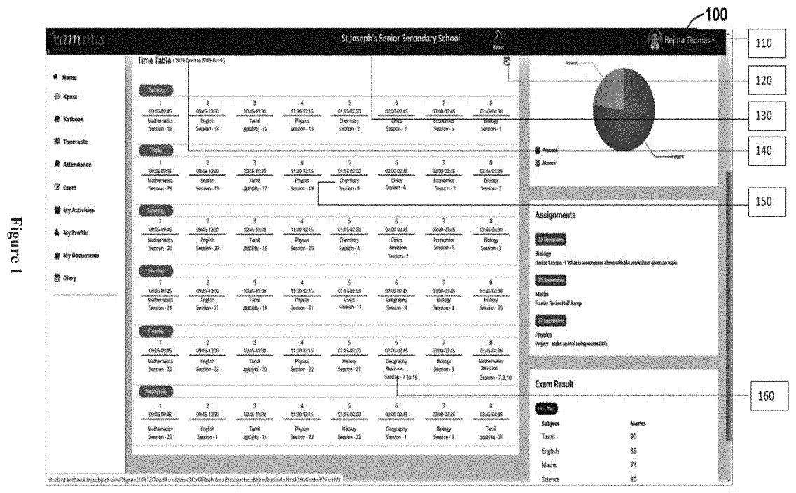

Referring to FIG. 1, an embodiment of the present invention illustrates a graphical representation of the timetable synchronised with the Session of each subject in the advanced digital text book/digital document 100. The folder 100 includes, (110) the profile picture of the Student, (120) the calendar, (130) the Education Institution Name (School, College etc), (140) the time period of timetable, (150) the session number of the related subject, (160) the revision of the sessions in the subject for particular period.

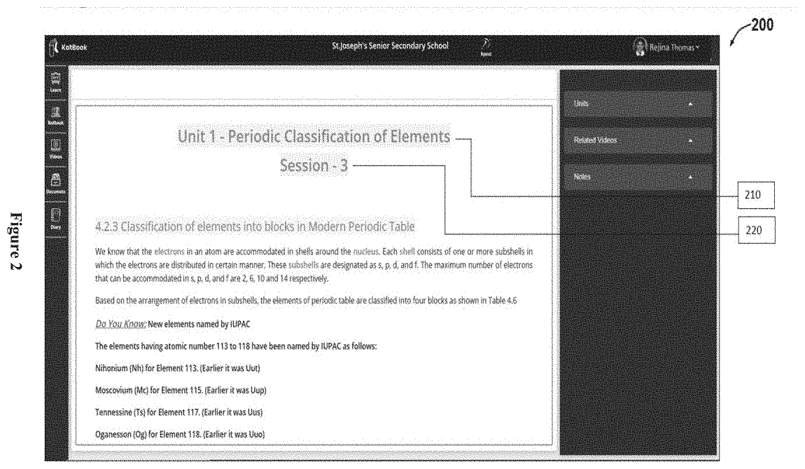

Referring to FIG. 2, an embodiment of the present invention illustrates a graphical representation of the student view of the of the advanced digital text book/digital document 200. The folder 200 includes (210) the Unit No and Unit Name. (220) the session No.

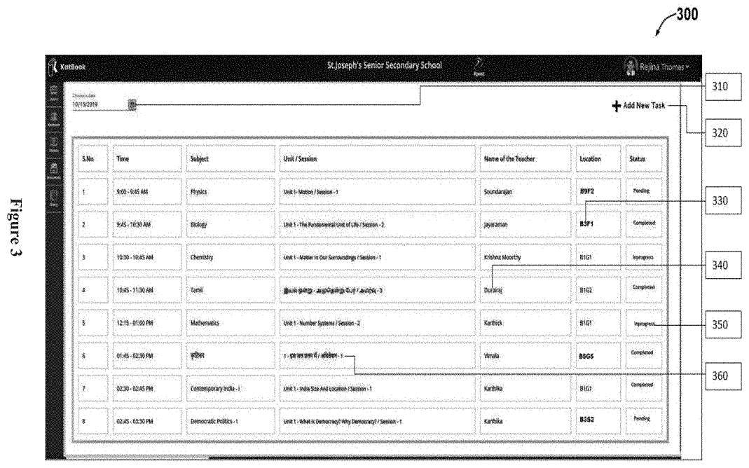

Referring to FIG. 3, an embodiment of the present invention illustrates a graphical representation of the student view of the timetable after clicking the particular date in the calendar in advanced digital textbook/digital document 300. The folder 300 includes (310) Calendar, (320) location, (330) name of the faculty (Teacher/Lecturer/Professor/Moderator), (340) status of the session completion, (350) unit name and session no.

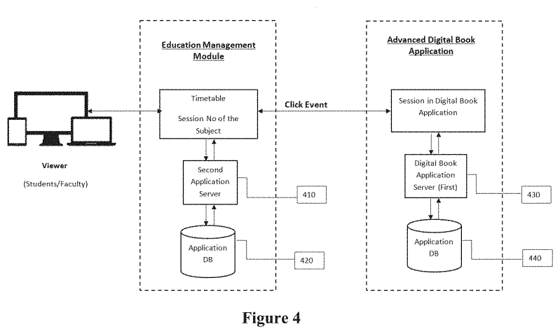

Referring to FIG. 4, an embodiment of the present invention illustrates a graphical representation showing synchronizing of a subject in a class timetable to the particular session in the advanced digital text book/digital document 400. The folder 400 includes (410) second application server, (420) Education Management Module Application DB, (430) Digital Book Application Server (First), (440) Advanced Digital Book Application DB.

By clicking the session number of the particular period in the timetable, it redirects to the respective session page of the subject in the advanced digital textbook. While clicking the session number in the timetable, the data stored in the database get fetched and viewed from the server.

According to another embodiment of the present invention, the schedule of classes displayed on the display of the user device comprises session number along with unit number of the specified subject for a particular scheduled class, the teacher details, location of the scheduled class.

According to an embodiment of the present invention, referring to FIG. 4, the method for displaying a virtually collaborated, multi-layered advanced digital text book/digital document synchronized with a corresponding timetable/schedule of classes for an educational institution having a curriculum, a plurality of faculties and a plurality of students comprises receiving, by a second application server, the user input for displaying a specified content of a specific subject of the curriculum which is displayed within the timetable for the specified time period, fetching by the second application server, from a database operably coupled to a first application server, the specified content of the specific subject of the curriculum synchronized with the specific timetable for the specified time period received as user input; and displaying the specified content on the display of the user device.

According to another embodiment of the present invention, an improved system of synchronizing class timetable with session of each subject for each class separately in the advanced digital textbook for the convenience of the faculties and all the students is disclosed. The said system is either device based or device independent used for school, college, university etc. The system comprises an Institution Management (ERP Software) on a digital cloud server to transmit the data to various educational institutions, a digital communication device (desktop computers, laptop computers, digital tablets, mobile smart phones like that) to receive and display the communication and advanced digital textbook data, and a structured collaborative advanced digital textbook having a user-friendly graphical interface for displaying the synchronized class timetable for the faculties/students in the advanced digital textbook. The system allows all the stakeholders—faculties, students and parents to view the synchronized timetable through any electronic devices like laptop computers, desktop computers, digital tablets, smart mobile phone devices etc.

Another embodiment of the present invention provides a computer program product comprising instruction, to perform a method for displaying a virtually collaborated, multi-layered advanced digital text book/digital document synchronized with a corresponding schedule of classes for an educational institution having a curriculum, a plurality of teachers, and a plurality of students, the method comprising the steps of: receiving a user input for displaying a schedule of classes for a specified time period; displaying the timetable for the specified time period, on a display of a user device; receiving a user input for displaying a specified content of a specific subject of the curriculum which is displayed within the timetable for the specified time period; and displaying, on the display of a user device, the specified content of the specific subject of the curriculum synchronized with the timetable for the specified time period received as user input.

In all the aforementioned embodiments, a user device includes all types of communication devices such as Mobile Smart Phones, Desktop Computers, Laptop Computers, Digital Tablets and the like. The present invention also relates to know about the faculty handling the subject and the class venue by the student in advance.

The aforementioned embodiments of the present invention facilitate viewing of the timetable (schedule of classes) by every faculty, students (of the specific class) with separate login for each one. The timetable (schedule of classes) can be viewed for the particular day or for the week or a specific period of time as per the selection. The invention additionally relates to a user-friendly mechanism of viewing the Revision of the session in the advanced digital textbook by the students from the class timetable and faculty as per the subjects they handle.

In an exemplary implementation of an aforementioned embodiment of the present invention, every student can view the name of the faculty handling the subject and the session going to be taught for the day. The timetable also facilitates to show the status of the session completion. Inevitably the half-finished session become the planned session for the next day. Following up can be done effortlessly for each session of the subject every day. The timetable has many aspects, which aid the Faculty/Students to identify and clarify about the class details (session number, revision number, subject, faculty name, and class venue (location) for their more specific studies and teaching. This well-constructed synchronized class timetable with the advanced digital text book comforts both faculties and students to get done with their tasks without any delay, avoid back to back classes, modify lesson plans and ensures the lesson completion on time.

It will be appreciated that variations of the above-disclosed and other features and functions, or alternatives thereof, may be desirably combined into many other different systems or applications. Also, unforeseen or unanticipated alternatives, modifications, variations or improvements therein may be subsequently made by skilled in the art which are also intended to be encompassed by the following claims.

I claim:

1. A method for displaying a virtually collaborated, multi-layered advanced digital text book/digital document synchronized with a corresponding timetable/schedule of classes for an educational institution having a curriculum, a plurality of teachers, and a plurality of students, the method comprising the steps of:
receiving a user input for displaying a timetable for a specified time period;
displaying the timetable for the specified time period, on a display of a user device:
receiving a user input for displaying a specified content of a specific subject of the curriculum which is displayed within timetable for the specified time period; and
displaying, on the display of a user device, the specified content of the specific subject of the curriculum synchronized with the timetable for the specified time period received as user input.

2. The method as claimed in claim 1, wherein the schedule of classes comprises session number along with unit number of the specified subject for a particular scheduled class, the teacher details, location of the scheduled class, wherein the details of the schedule of classes to be held can also be viewed from a diary of the student and the faculty, and wherein the details of the schedule of classes to be held can also be viewed from a dashboard.

3. The method as claimed in claim 1, further comprises the steps of:
receiving, by a second application server, the user input for displaying a specified content of a specific subject of the curriculum which is displayed within the timetable for the specified time period;
fetching, by the second application server, from a database operably coupled to a first application server, the specified content of the specific subject of the curriculum synchronized with the specific timetable for the specified time period received as user input; and
displaying the specified content on the display of the user device.

4. A virtually collaborated, multi-layered advanced digital text book/digital document display system, comprising at least one user device communicably coupled to a first application server and a second application server, said advanced digital text book/digital document synchronized with a corresponding timetable/schedule of classes for an educational institution having a curriculum, a plurality of teachers, and a plurality of students, said system being configured to:
receive a user input for displaying a timetable for a specified time period;
display the timetable for the specified time period, on a display of a user device;
receive a user input for displaying a specified content of a specific subject of the curriculum which is displayed within the timetable for the specified time period; and
display, on the display of a user device, the specified content of the specific subject of the curriculum synchronized with the specific schedule of classes for the specified time period received as user input.

5. The system as claimed in claim 4, wherein the timetable comprises session number along with unit number of the specified subject for a particular scheduled class, the teacher details, location of the scheduled class, wherein the details of the schedule of classes to be held can also be viewed from a diary of the student and the faculty, and wherein the details of the schedule of classes to be held can also be viewed from a dashboard.

6. The system as claimed in claim 4, wherein the system is configured to:
receive, by the second application server, the user input for displaying a specified content of a specific subject of the curriculum which is displayed within the timetable for the specified time period;
fetching, by the second application server, from a database operably coupled to a first application server, the specified content of the specific subject of the curriculum synchronized with the timetable for the specified time period received as user input; and
displaying the fetched specified content on the display of the user device.

7. The system as claimed in claim 4, wherein the user device is a digital communication device of a teachers or a student, wherein said communication device is a desktop computer, laptop computer, digital tablet, mobile smart phone and the like, said user device being configured to receive and display the communication and the multi-layered advanced digital text book/digital document.

8. A computer program product comprising instructions, to perform a method for displaying a virtually collaborated, multi-layered advanced digital text book/digital document synchronized with a corresponding schedule of classes for an educational institution having a curriculum, a plurality of teachers, and a plurality of students, the method comprising the steps of:
receiving a user input for displaying a schedule of classes for a specified time period;
displaying the timetable for the specified time period, on a display of a user device;
receiving a user input for displaying a specified content of a specific subject of the curriculum which is displayed within the timetable for the specified time period; and
displaying, on the display of a user device, the specified content of the specific subject of the curriculum synchronized with the timetable for the specified time period received as user input.
